(19) United States
(12) Patent Application Publication
(10) Pub. No.: US 2024/0294192 A1
(43) Pub. Date: Sep. 5, 2024

(54) VEHICLE CONTROL SYSTEM WITH INTERFACE UNIT

(71) Applicant: ZF CV Systems Global GmbH, Bern (CH)

(72) Inventors: Christoph Barth, Hannover (DE); Malte Berroth, Berlin (DE); Otmar Struwe, Hannover (DE); Oliver Wulf, Neustadt (DE)

(21) Appl. No.: 18/661,215

(22) Filed: May 10, 2024

Related U.S. Application Data
(63) Continuation of application No. PCT/EP2022/080432, filed on Nov. 1, 2022.

(30) Foreign Application Priority Data
Nov. 10, 2021 (DE) 10 2021 129 193.3

(51) Int. Cl. B60W 60/00; B60W 50/02

(52) U.S. Cl. CPC B60W 60/0018; B60W 50/0205; B60W 2300/00; B60W 2556/00

(57) ABSTRACT

A vehicle control system is for controlling a vehicle, in particular a utility vehicle, in an autonomous operating mode. The vehicle control system includes a virtual driver configured to carry out trajectory planning to generate a trajectory. The vehicle control system is configured to control the vehicle using the trajectory and includes an interface unit, which is configured to obtain the trajectory from the virtual driver and to actuate at least one vehicle actuator of the vehicle control system to control the vehicle using the trajectory, wherein the interface unit functionally connects the virtual driver and the at least one vehicle actuator. A method is for controlling a vehicle, a use of the vehicle control system and a vehicle having a vehicle control system.

### CROSS-REFERENCE TO RELATED APPLICATIONS

This application is a continuation application of international patent application PCT/EP2022/080432, filed Nov. 1, 2022, designating the United States and claiming priority from German application 10 2021 129 193.3, filed Nov. 10, 2021, and the entire content of both applications is incorporated herein by reference.

### TECHNICAL FIELD

The disclosure relates to a vehicle control system for controlling a vehicle, in particular a utility vehicle, in an autonomous operating mode. The vehicle control system includes a virtual driver configured to carry out trajectory planning to generate a trajectory; wherein the vehicle control system is configured to control the vehicle using the trajectory. The disclosure further relates to a method for controlling a vehicle, to the use of a vehicle control system, and to a vehicle.

### BACKGROUND

Vehicle control systems are configured to actuate one or more actuators of a vehicle in such a way that a driving task of the vehicle is carried out. Vehicle control systems control the lateral and longitudinal acceleration of vehicles partially or completely independently of a human user. Completely user independent control is referred to as fully autonomous operation, while in semi-autonomous operation only some driving tasks are performed by the vehicle control system. The term autonomous operation covers both fully autonomous control of the vehicle and semi-autonomous control.

In order to operate a driverless vehicle, many different sensors are required to record the environment as well as high computing power to evaluate the sensor data streams. Based on sensor data, a virtual driver of the autonomous vehicle control system carries out trajectory planning and obtains a trajectory that is intended to fulfill a driving task, such as an autonomous drive from point A to point B. In order to fulfill the driving task or to move the vehicle along the trajectory, the vehicle control system actuates one or more vehicle actuators of the vehicle. For example, the vehicle control system actuates a steering system, a drive motor and a brake system in such a way that the vehicle moves along a predefined path at a speed specified in the trajectory. While the vehicle executes the trajectory, the autonomous vehicle control system monitors the environment and modifies the trajectory if necessary.

The Society of Automotive Engineers (SAE) has developed a common five stage scheme for classifying the degree of automation of vehicles that are controlled by an autonomous vehicle control system. Even in the event of an error, the vehicle must be able to continue operating safely until it can no longer pose a danger. In autonomy levels 3 to 5, the driving environment is monitored by the autonomous driving system, wherein in level 3 the human user takes over full control of the vehicle in the event of an error in the autonomous driving system. In autonomy levels 4 and 5, monitoring by the human user is no longer provided. Errors by the vehicle control system, for example the virtual driver, must then not lead to accidents or dangerous situations.

In the automotive industry, long supply chains and the purchase of partly complete assemblies from suppliers by original equipment manufacturers (OEMs) are widespread, as otherwise the development of highly complex modern vehicles would be impossible or virtually impossible due to the often short product cycles. For example, utility vehicle OEMs often purchase complete brake systems from suppliers such as the present applicant and install them in their utility vehicles. Safe and simple integration of purchased vehicle subsystems is particularly important for complex vehicle control systems for autonomous or semi-autonomous driving. For example, correct interaction between a virtual driver provided by the utility vehicle OEM and a brake system provided by a supplier must be ensured under all circumstances in order to prevent potentially dangerous situations and accidents.

U.S. Pat. No. 10,611,381 B2 discloses an autonomous vehicle with a virtual driver and several vehicle actuators. Control modules of the vehicle actuators provide recommendations for safe driving maneuvers (so called minimal risk maneuvers) to an MRC controller. In the event of an error, the MRC controller selects one of these recommendations and commands the virtual driver to control the vehicle or the vehicle actuators based on the selected recommendation. The virtual driver is directly connected to the vehicle actuators for this purpose and controls the actuators. The disadvantage of this is that if the virtual driver makes a mistake, it is not possible to prevent the virtual driver from accessing the vehicle actuators. Furthermore, access by the virtual driver is not monitored separately, even when switching to an autonomous operating mode.

### SUMMARY

It is an object of the disclosure to provide a vehicle control systems for controlling a vehicle, methods for controlling a vehicle, and vehicles that are inexpensive or use inexpensive components, ensure increased safety and are easy to integrate.

The present disclosure achieves the aforementioned object in a first aspect in a vehicle control system of the aforementioned type via an interface unit which is configured to receive the trajectory from the virtual driver and to actuate at least one vehicle actuator of the vehicle control system to control the vehicle using the trajectory, wherein the interface unit functionally connects the virtual driver and the at least one vehicle actuator. According to the disclosure, a separation of partial functions is thus provided. During operation, the virtual driver carries out the trajectory planning and thus generates the trajectory, while the at least one vehicle actuator is actuated by the interface unit. The interface unit translates the trajectory into specific requirements of the vehicle actuators and actuates them accordingly. For example, if the trajectory involves the vehicle driving straight ahead at a constant speed on an incline, the interface unit actuates a drive of the vehicle (or a corresponding control unit of the drive) in such a way that the speed is kept constant.

The division of trajectory planning and actuation of the vehicle actuators is particularly advantageous in that it is still possible to actuate at least one vehicle actuator in the event of an error by the virtual driver. An error by the virtual driver does not automatically lead to a total failure of the system. Furthermore, the interface enables simple integration or combination of different vehicle subsystems. For example, the interface can preferably be configured to receive the trajectory in a common data format. The virtual driver then only needs to provide the trajectory in a common data format and does not have to be matched to all of the vehicle's subsystems. The interface can thus be easily combined with virtual drivers from different manufacturers in an advantageous way.

The interface unit functionally connects the virtual driver to the at least one vehicle actuator. This means that the virtual driver and the at least one vehicle actuator are merely indirectly connected to each other via the interface unit. While the vehicle is moving, the virtual driver, the interface unit and the at least one vehicle actuator interact in such a way that the vehicle is moved along the trajectory. Preferably, the trajectory is processed or translated into actuator requests and/or actuator control commands exclusively by the interface unit. It should be understood that, in the context of this application, the interface unit is more than a mere line element between the virtual driver and the at least one vehicle actuator. Rather, the interface unit performs functional tasks, such as, in particular, further processing and/or translation of the trajectory into control commands for one or more vehicle actuators. For example, the interface unit can extract control commands for individual vehicle actuators from the trajectory. Preferably, it can also be provided that the interface unit functionally connects the virtual driver to a first vehicle actuator and that the virtual driver is directly connected to a second vehicle actuator.

In a first embodiment, the virtual driver is functionally connected to the at least one vehicle actuator exclusively via one or more interface units. There is then no functional connection between the virtual driver and the at least one vehicle actuator via other components that are not interface units for actuating the vehicle actuators. In this embodiment, the interface unit(s) alone is (are) intended in particular to actuate the at least one vehicle actuator using the trajectory. This facilitates system integration. Furthermore, it can be ensured that the virtual driver can only access the vehicle actuators via the interface unit. The ability to actuate the vehicle actuators is retained even in the event of an error by the virtual driver and the safety of the vehicle control system is increased.

Preferably, the virtual driver and the interface unit are virtual subsystems of a control unit. For example, the interface unit and the virtual driver can be independent programs that are executed on a control unit. Virtual subsystems allow the function to be separated and still enable a simple and compact configuration. Furthermore, already known control units can preferably be further developed to implement the disclosure.

Alternatively, the interface unit and the virtual driver can also be separate systems. For example, the virtual driver can preferably be a first computing core of a control unit while a second computing core of the control unit forms the interface unit. Further preferably, the virtual driver can be a first ECU of a control unit and the interface unit can be a second ECU of the same control unit. However, it may alternatively and preferably also be provided that the virtual driver and the interface unit are configured as completely physically separate systems. For example, the virtual driver and the interface unit can preferably be configured as separate modules, which are particularly preferably arranged in separate housings. Complete separation of the interface unit and virtual driver allows particularly simple integration of the vehicle control system into a vehicle.

In a further embodiment, the virtual driver has a planning control unit for carrying out the trajectory planning, wherein the interface unit has an electronic interface control unit which is independent of the planning control unit and is configured to process the trajectory. The independent configuration of the planning control unit and interface control unit ensures particularly failsafe performance. A failure of the planning control unit does not automatically result in a lack of access to vehicle actuators.

Preferably, the vehicle control system has a first bus system and a second bus system, wherein the virtual driver is connected to the first bus system, the at least one vehicle actuator is connected to the second bus system, and wherein the interface unit is connected to the first bus system and the second bus system. The first and/or second bus system is preferably an Ethernet bus system, a CAN bus system, a CAN FD bus system, a LIN bus system, a MOST bus system, a FlexRay bus system and/or a TTCAN bus system. As the virtual driver and the at least one vehicle actuator are arranged in separate bus systems, communication or functional interaction between these units can only take place via the interface unit. This facilitates the separation of the virtual driver and vehicle actuators.

In a preferred development, the interface unit is configured to carry out one or more safety functions of the vehicle control system. The interface unit then performs at least two functions: actuating the at least one vehicle actuator using the trajectory, and the safety function.

Preferably, the safety function is an admissibility check, which is intended to determine whether the trajectory complies with one or more predefined constraints, preferably driving-dynamic constraints predefined for the vehicle. Driving dynamic constraints are preferably selected from a maximum lateral acceleration of the vehicle, a minimum braking distance of the vehicle, a minimum curve radius of the vehicle, a maximum gradient (and/or slope) that can be traveled by the vehicle, a minimum path width that can be traveled by the vehicle, and/or a minimum path height that can be traveled by the vehicle. Further constraints can preferably be status information from vehicle subsystems. The interface unit is configured to determine, as a safety function, whether the trajectory generated by the virtual driver complies with one or more constraints. If this is not the case, this is recognized by the interface unit. For example, if the virtual driver generates a trajectory that contains a cornering movement of the vehicle in which a maximum lateral acceleration of the vehicle is exceeded (risk of tipping), this is detected by the interface unit. Preferably, the interface unit can determine whether the trajectory was generated based on a fully functional brake system, although only an emergency braking function is available due to a malfunction.

In an embodiment, the interface unit is configured to control the at least one vehicle actuator using the trajectory only if the trajectory complies with all predefined constraints. The interface unit thus preferably prevents the vehicle from being actuated using an incorrect trajectory. For example, this can prevent the vehicle from tilting, which would be caused by cornering with excessive lateral acceleration.

Preferably, the safety function is an error monitoring function intended to determine whether there is an error in the vehicle control system, the vehicle and/or a vehicle subsystem. It should be understood that the safety function may include both fault monitoring and admissibility checking. As part of fault monitoring, the interface unit can, for example, be configured to determine whether a brake system of the vehicle is fully functional or can provide the maximum braking power. Preferably, the interface unit can thus serve as a redundancy level for fault monitoring carried out by a main control unit of the vehicle. However, the interface unit can also perform the only fault monitoring of a vehicle.

According to an embodiment, the interface unit is configured to determine whether the trajectory is feasible in response to a detection of an error of the vehicle control system, the vehicle and/or the vehicle subsystem. A trajectory is feasible as long as the vehicle is set up to follow the trajectory despite the error. For example, in a case in which a brake system of the vehicle is faulty and only an emergency braking function is available, the trajectory can still be executed if the braking maneuvers to be carried out as part of the trajectory involve a sufficiently low deceleration. Furthermore, it is also possible, for example, to drive straight ahead even if one of the vehicle's steering systems is inoperable.

In a preferred development, the interface unit is configured to actuate the at least one vehicle actuator of the vehicle control system as a safety function to control the vehicle using a safety trajectory. The interface unit can thus control the vehicle actuator using the trajectory or using the safety trajectory. The safety trajectory preferably has a reduced range of functions relative to the trajectory. The safety trajectory preferably describes the planned movement path of the vehicle together with the vehicle dynamics variables, such as speed, deceleration and/or lateral acceleration of the vehicle.

Preferably, the interface unit is configured to actuate the at least one vehicle actuator of the vehicle control system to control the vehicle using the safety trajectory if the trajectory violates at least one predefined constraint. The interface unit is preferably configured to independently choose between the trajectory and the safety trajectory. If the trajectory generated by the virtual driver violates a predefined constraint, then the interface unit actuates the at least one vehicle actuator using the safety trajectory. On the other hand, if the trajectory does not violate a constraint, the interface unit uses the trajectory to control the vehicle actuator. It should be understood that the interface unit can also take into account other factors, such as preferably an error monitoring result, when selecting between the trajectory and the safety trajectory. Preferably, the interface unit is configured to actuate the at least one vehicle actuator of the vehicle control system to control the vehicle using the safety trajectory if the trajectory cannot be performed or cannot be performed correctly.

Preferably, the safety trajectory is or includes one of the following maneuvers: emergency braking maneuver, stop in lane maneuver, stop on hard shoulder maneuver, limp home maneuver, mission complete maneuver. An emergency braking maneuver corresponds to maximum braking of the vehicle without steering movement. A stop in lane maneuver, also known as a lane keeping braking maneuver, means that the vehicle continues to follow a lane in which the vehicle is located when the maneuver is initiated. It should be understood that the lane can also be curved or have a curve. The stop in lane maneuver is preferably carried out when there is no alternative lane that can be used. This is the case, for example, if the vehicle is driving on a single lane road or if a hard shoulder is blocked by a defective vehicle. In a stop on hard shoulder maneuver, also known as a lane change braking maneuver, the vehicle changes from a first lane, which it is driving in when the maneuver is initiated, to another accessible lane. The other lane is usually a second free lane, in particular a hard shoulder. As part of a stop on hard shoulder maneuver, the vehicle can also change lanes several times. A limp home maneuver involves the vehicle continuing to drive for a short time under certain conditions, for example at a restricted maximum speed. A mission complete maneuver involves driving to the planned destination. Mission complete maneuvers are preferably carried out when a non safety related system has an error.

Preferably, the safety function is the execution of safety planning to obtain a safety trajectory. By performing safety planning, the interface unit can ensure that a safety trajectory is available to actuate the at least one vehicle actuator even if the virtual driver is unable to function due to an error.

Preferably, the interface unit is configured to take into account a detected fault of the vehicle control system, the vehicle and/or the vehicle subsystem in the safety planning. Preferably, the safety planning takes into account the vehicle condition, in particular the speed, mass and lateral acceleration, as well as other ambient conditions and environmental influences. Such environmental conditions and environmental influences can be, for example, ambient temperature, road temperature, road conditions, lane widths, lane progression and traffic volume.

According to a preferred development, the interface unit is configured to carry out the safety planning in parallel with the trajectory planning of the virtual driver, and preferably continuously. The continuous execution of the safety planning ensures that an up to date safety trajectory is always available in the event of an error in a vehicle system or the virtual driver. It should be understood that a continuous execution can be a continuous adaptation of the safety trajectory. However, continuous execution of safety planning can also mean that a new safety plan is started immediately after a safety plan has been completed. Preferably, the interface unit is configured to carry out the safety planning regardless of whether the trajectory is feasible or not. This ensures that a current safety trajectory is available even in the event that the trajectory subsequently becomes infeasible.

In an embodiment, the interface unit is configured to switch between the autonomous operating mode and a manual operating mode of the vehicle control system, wherein the interface unit only actuates the at least one vehicle actuator when the autonomous operating mode is activated. In the manual operating mode, the at least one vehicle actuator is actuated manually by a driver of the vehicle. In the manual operating mode, for example, the driver can actuate a brake pedal of the vehicle in order to brake the vehicle. However, it is also possible for the interface unit to actuate the at least one vehicle actuator in the manual operating mode as a function of a manual user specification. For example, the driver can use an electronic brake pedal to provide a manual brake request to the interface unit, which in turn activates one or more brake cylinders in accordance with the manual brake request. However, the actuation is then not carried out using a trajectory.

Preferably, the vehicle control system has an activation switch, wherein the interface unit is configured to only switch to the autonomous operating mode if the activation switch is actuated. If the activation switch is not actuated, the interface unit cannot switch to the autonomous operating mode. This prevents automatic activation of the autonomous operating mode without a corresponding user request. Together with the interface unit, the activation switch serves as a safety device. It should be understood that the activation switch does not have to be physically actuated at all times. The activation switch can also be a simple button that is actuated by pressing it once and remains in this actuated state. Preferably, the activation switch is a button, a key switch, a toggle switch, a fingerprint scanner and/or a pin input device. A fingerprint scanner switches to an actuated position by scanning a fingerprint of an authorized person. Similarly, a pin input device switches by entering a correct character string (pin). Preferably, the activation switch can also be a voice recognition device. Preferably, the activation switch is configured to remain activated after actuation until it is reset. A reset is carried out, for example, by activating or deactivating the vehicle again.

In an embodiment, the interface unit is configured to only switch to the autonomous operating mode if the activation switch is actuated and a confirmation signal is provided at the interface unit. The autonomous operating mode is then only activated in response to a multi stage check. First, the activation switch must be actuated. If the activation switch is actuated, the interface unit preferably switches to a standby mode in which activation of the autonomous operating mode is possible in principle. However, only when the activation signal is also provided at the interface unit does the interface unit switch to the autonomous operating mode. For example, an activation switch configured as a key switch can be activated throughout the day and the interface unit only switches to the autonomous operating mode when the activation signal is provided, for example by pressing a separate button. The vehicle control system is thus particularly protected against unintentional activation of the autonomous operating mode.

Preferably, a confirmation signal can only be provided at the interface unit if the interface unit issues a release, wherein the interface is configured to determine whether predefined activation conditions are met and to only issue the release if the predefined activation conditions are met. The autonomous operating mode is then not activated in every case by actuating the activation switch and providing the confirmation signal, but only if the predefined activation conditions are also fulfilled. For example, one activation condition may be that the vehicle's brake system is fully functional. Activation of the autonomous mode despite an error in the brake system is thus preferably prevented.

Preferably, the system is configured to capture and/or receive actuator status data from the at least one vehicle actuator and/or vehicle status data and provide it to the virtual driver. The interface unit thus simplifies integration of the autonomous driver with the at least one vehicle actuator. Thus, the interface unit can be configured to communicate with the vehicle actuators and the virtual driver, and a separate adaptation of the virtual driver to all vehicle actuators is not necessary.

According to an embodiment, the interface unit is a virtual subsystem of a control unit. Preferably, this control unit is a brake control unit of a brake system, a steering control unit of a steering system, a transmission control unit, an engine control unit and/or a main control unit of a vehicle. This embodiment enables an advantageous dual use of an already existing control unit, which can reduce the complexity of the vehicle control system as well as costs for assembly, procurement and maintenance. Furthermore, brake control units, steering control units, transmission control units, engine control units and/or main control units are already very reliable today and are particularly suitable for partial use as an interface unit.

Preferably, the interface unit is a brake control unit of a brake system, a steering control unit of a steering system, a transmission control unit, an engine control unit and/or a main control unit of a vehicle or is integrated into a brake control unit of a brake system, a steering control unit of a steering system, a transmission control unit, an engine control unit and/or a main control unit of a vehicle. The interface unit is then preferably a separate computing unit in one of the aforementioned units. However, it is also possible for the interface unit to be configured only as a separate computing core or virtual subsystem of one of the aforementioned units.

In a preferred development, the vehicle control system also has a redundancy driver and/or a redundancy interface unit, wherein the virtual driver and/or the interface unit are supplied by an operating voltage supply, and wherein the redundancy driver and/or the redundancy interface unit are supplied by a redundancy voltage supply that is independent of the operating voltage supply. Both the interface and the redundancy interface unit are configured to control vehicle actuators. In an error free case, the virtual driver and/or the interface unit preferably function completely independently of the redundancy driver and/or the redundancy interface. The redundancy driver and/or the redundancy interface only intervene if the virtual driver and/or the interface are partially or completely inoperative due to an error.

Preferably, the redundancy driver has a reduced functionality compared to the virtual driver and/or the redundancy interface unit has a reduced functionality compared to the interface unit. A simplified safety trajectory can also be implemented with the aid of a simplified redundancy driver and/or a redundancy interface unit, which are significantly less expensive than the virtual driver and/or the interface unit. For example, planning a stop in lane maneuver requires a less complex virtual driver than planning a complex driving task over a distance of several kilometers on public roads. Furthermore, for redundancy trajectories, preferably only a few vehicle actuators need to be actuated, so that the redundancy interface unit can have a reduced complexity or reduced functionality compared to the interface unit.

In a second aspect, the problem stated at the outset is solved by a method for controlling a vehicle, in particular a utility vehicle, including a vehicle control system, preferably a vehicle control system according to one of the embodiments of the first aspect of the disclosure, including: performing trajectory planning, for obtaining a trajectory, via a virtual driver when an autonomous operating mode is activated; providing the trajectory to an interface unit; processing the trajectory by the interface unit, this being performed independently of the virtual driver; and actuating at least one vehicle actuator of the vehicle control system to control the vehicle by the interface unit using the trajectory. It should be understood that the method for controlling a vehicle according to the second aspect of the disclosure, and the vehicle control system according to the first aspect of the disclosure have the same or similar sub aspects. In this respect, full reference is made to the above description for these aspects.

Trajectory planning is carried out by the virtual driver, who then provides the resulting trajectory to the interface unit. The interface unit processes the trajectory. Processing is preferably a conversion of the complex trajectory into individual control commands for the at least one vehicle actuator. If, for example, the trajectory concerns cornering of the vehicle with simultaneous deceleration of the vehicle, then the interface unit translates this trajectory into a corresponding steering request for a steering system of the vehicle and into a braking request for the brake system of the vehicle. For this purpose, the interface unit is configured independently of the virtual driver so that the complexity of the virtual driver can be reduced. Furthermore, integration of the virtual driver with vehicle subsystems from different suppliers is simplified.

Preferably, data and/or signals are transmitted exclusively via the interface unit between the virtual driver and the at least one vehicle actuator. In this case, it is impossible for the virtual driver to actuate the at least one vehicle actuator by bypassing the interface unit. The method also preferably includes: performing a safety function by the interface unit. The interface unit is preferably configured to carry out one or more safety functions of the vehicle control system.

According to an embodiment, performing a safety function includes: fault monitoring of the vehicle control system, the vehicle and/or a vehicle subsystem to detect faults. The interface unit monitors the vehicle control system, the vehicle and/or at least one vehicle subsystem and determines whether there is an error in one of these systems. If such an error is present, this is determined by the interface unit so that further steps can be carried out if necessary.

Preferably, performing a safety function further includes: determining whether the trajectory is feasible if an error of the vehicle control system, the vehicle and/or a vehicle subsystem is detected. For example, the interface unit checks whether a deceleration of the vehicle required as part of a trajectory can be provided at all if a brake system of the vehicle has an error.

Preferably, performing a safety function further includes: actuating at least one vehicle actuator of the vehicle control system using a safety trajectory, preferably in response to a determination that the trajectory cannot be performed or cannot be performed correctly. The actuation of the at least one vehicle actuator using the safety trajectory is preferably performed instead of actuating at least one vehicle actuator using the trajectory. This preferably ensures that the vehicle or the at least one vehicle actuator is always controlled using a feasible trajectory.

In a preferred further development, the method further includes: performing safety planning to obtain a safety trajectory. The safety planning is preferably carried out in parallel with further steps. Particularly preferably, the safety planning is carried out in parallel with the trajectory planning. Further preferably, the safety planning is repeated cyclically or performed continuously.

Preferably, the method further includes: acquiring sensor data and/or sensor signals via the interface unit; and providing the sensor data and/or sensor signals to the virtual driver by the interface unit and/or querying the sensor data and/or sensor signals from the interface unit by the virtual driver. Particularly preferred is the acquisition and provision of sensor data and/or sensor signals: evaluating the sensor data and/or sensor signals by the interface unit and providing a sensor evaluation to the virtual driver or querying the sensor evaluation from the interface unit by the virtual driver. The interface unit thus functions not only as an interface between the virtual driver and the at least one vehicle actuator, but preferably also as an interface between sensors and the virtual driver.

In an embodiment, the method further includes: activating the autonomous operating mode by the interface unit. Preferably, the method further includes: actuating an activation switch, wherein the activation of the autonomous operating mode is only carried out when the activation switch is actuated. Actuating the activation switch is a necessary prerequisite for activating the autonomous operating mode. However, it is also possible that further prerequisites must be fulfilled before the interface unit activates the autonomous operating mode.

Preferably, the method further includes: providing a confirmation signal, wherein the activation of the autonomous operation mode is only performed when the activation switch is actuated and the confirmation signal is provided. The activation switch preferably remains actuated until it is reset. The actuation of the activation switch and the confirmation signal can preferably also be carried out at different times. For example, an activation switch configured as a pin input device can be actuated when the vehicle is started by entering a predefined character string, while the confirmation signal is not provided until several hours later, for example by pressing a button.

According to a preferred further development, the method further includes: checking whether predefined activation conditions are fulfilled by the interface unit, wherein the provision of the confirmation signal is only possible if all predefined activation conditions are fulfilled. For example, the interface unit can check whether all of the vehicle's sensors required to carry out autonomous operation are ready for use before activating the autonomous operating mode.

Preferably, the method further includes: determining whether the trajectory complies with one or more predefined constraints, preferably predefined driving dynamic constraints for the vehicle, wherein the actuation of at least one vehicle actuator of the vehicle control system for controlling the vehicle is performed by the interface unit using the trajectory only if the trajectory complies with all predefined constraints.

The present disclosure solves the problem in a third aspect by using a vehicle control system according to the first aspect of the disclosure for controlling a vehicle, preferably via a method according to the second aspect of the disclosure.

In a fourth aspect, the disclosure solves the aforementioned problem via a vehicle, in particular a utility vehicle, having a vehicle control system according to the first aspect of the disclosure.

It should be understood that the use of a vehicle control system according to the third aspect of the disclosure and the vehicle according to the fourth aspect of the disclosure have the same or similar sub aspects as the vehicle control system according to the first aspect of the disclosure and the method according to the second aspect of the disclosure.

### BRIEF DESCRIPTION OF DRAWINGS

The invention will now be described with reference to the drawings wherein:

FIG. 1 is a schematic representation of a vehicle control system according to a first embodiment;

FIG. 2 is a schematic representation of a trajectory;

FIG. 3 is a schematic representation of a vehicle control system according to a second embodiment;

FIG. 4 shows a stop in lane maneuver of a vehicle;

FIG. 5 shows a stop on hard shoulder maneuver of a vehicle;

FIG. 6 is a schematic flow chart for switching to an autonomous operating state;

FIG. 7 is a schematic representation of a vehicle control system according to a third embodiment;

FIG. 8 is a schematic flow chart for an embodiment of the method; and,

FIG. 9 shows a vehicle.

### DETAILED DESCRIPTION

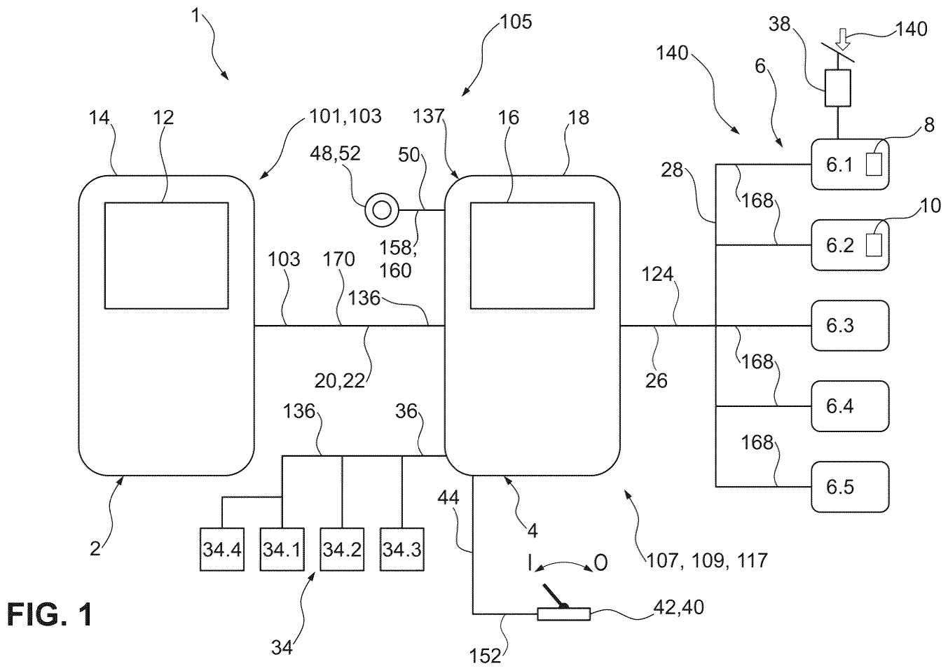

FIG. 1 illustrates a vehicle control system 1 that has a virtual driver 2, an interface unit 4 and several vehicle actuators 6. In this embodiment, the vehicle actuators 6 include a brake system 6.1 with a brake control unit 8, a steering system 6.2 with a steering control unit 10, a transmission control unit 6.3, an engine control unit 6.4 and a main control unit 6.5.

The virtual driver 2 has a planning control unit 12 which is arranged in a first housing 14. The virtual driver 2 is configured to carry out trajectory planning 101 in order to generate a trajectory 103, wherein the trajectory planning 101 is only carried out by the virtual driver 2 in this embodiment if an autonomous operating mode 105 is activated.

The interface unit 4 includes an interface control unit 16, which is arranged in a second housing 18. The virtual driver 2 and the interface unit 4 are configured here as separate elements, that is, physically separated from one another. The virtual driver 2 is connected to the interface unit 4 via a first connection 20, which in this case is a first bus system 22. The first bus system 22 is preferably a CAN bus, a LIN bus, a FlexRay bus, a MOST bus, a K Line bus, an SAE J1850 bus or an Ethernet connection. Via the first bus system 22, the virtual driver 2 provides the trajectory 103, which was determined as part of the trajectory planning 101, to the interface unit 4. However, it is also possible for the interface unit 4 to request the trajectory 103 from the virtual driver 2.

The interface unit 4 further processes the trajectory 103 provided by the virtual driver via the first bus system 22 in its interface control unit 16 and actuates the vehicle actuators 6 using the trajectory 103.

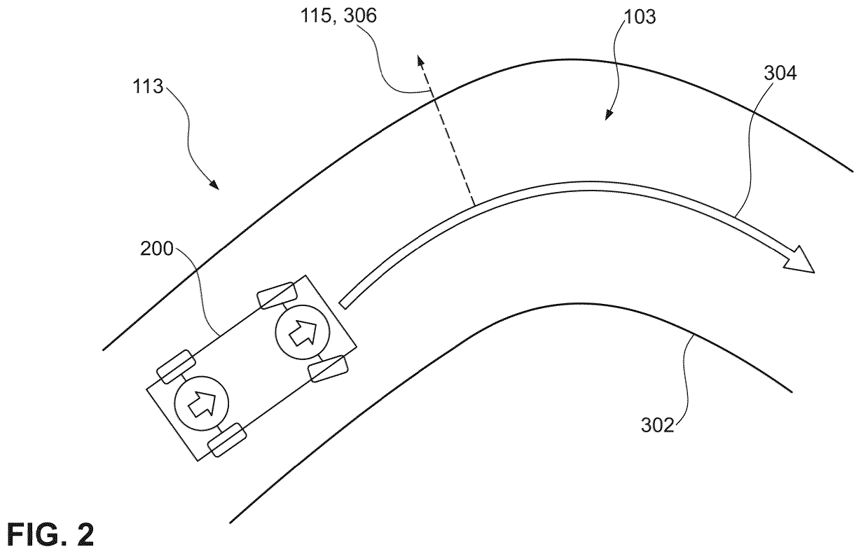

FIG. 2 illustrates a trajectory 103, which in this case is a cornering movement of a vehicle 200 along a curved roadway 302. In addition to information about the planned route, which is illustrated by the arrow 304, the trajectory 103 also contains speed information. The trajectory 103 provided by the virtual driver 2 specifies the (possibly variable) speed at which the vehicle 200 is to travel the planned route 304. Here, the speed of the vehicle 200 should remain constant along the planned route 304. An engine 218 of the vehicle 200 (not shown in FIG. 1) must then be actuated by the engine control unit 6.4 in such a way that the speed of the vehicle 200 remains constant. In addition, a steering angle of the steering system 6.2 must be set so that the vehicle 200 follows the planned route 304. The trajectory 103 therefore results in individual requirements for the vehicle actuators 6.

The interface unit 4 receives the trajectory 103 and uses it to determine control commands 124 for the individual vehicle actuators 6. The interface unit 4 then provides these control commands 124 to the vehicle actuators 6. For this purpose, the vehicle actuators 6 and the interface unit 4 are connected via a second connection 26, which is configured here as a second bus system 28. The first bus system 22 and the second bus system 28 can be configured identically in principle. For example, both the first bus system 22 and the second bus system 28 can be a CAN bus.

The interface 4 functionally connects the virtual driver 2 to the vehicle actuators 6. The trajectory 103 generated by the virtual driver 2 is converted by the vehicle actuators 6 so that the vehicle 200 follows the trajectory 103. The interface unit 4 is arranged between the virtual driver 2 and the vehicle actuators 6. The virtual driver 2 and the vehicle actuators 6 are only functionally connected by the interface unit 4. Here, the separation of virtual driver 2 and vehicle actuators 6 is of a physical nature, since the virtual driver 2 and the vehicle actuators 6 are arranged in separate bus systems 22, 28. The interface unit 4 is connected to both the first bus system 22 and the second bus system 28, so that it receives the trajectory 103 from the first bus system 22 and controls the vehicle actuators 6 using the trajectory 103 by providing corresponding control commands 124 on the second bus system 28. However, it may also be provided that the exclusive connection of virtual driver 2 and vehicle actuators 6 is accomplished by virtual disconnection. For example, the vehicle actuators can be configured on the software side to only receive control commands 124 that are provided by the interface unit 4.

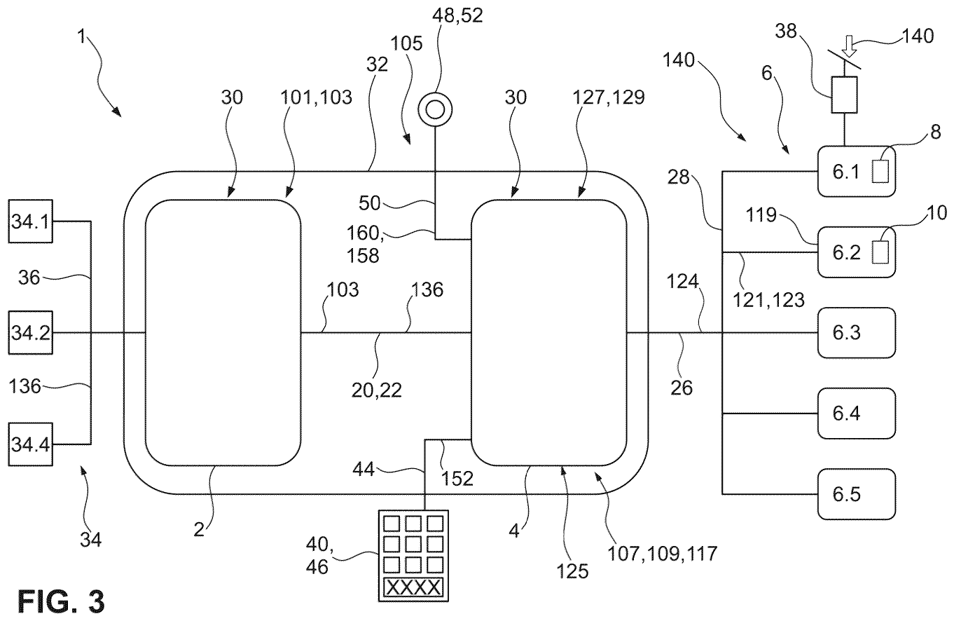

FIG. 3 illustrates a second alternative configuration of the vehicle control system 1. In this variant, the virtual driver 2 and the interface unit 4 are configured as virtual subsystems 30 of a control unit 32. The connection 20 between virtual driver 2 and interface unit 4 is also at data level (or virtual). However, the vehicle control systems 1 according to the first embodiment (FIG. 1) and according to the second embodiment (FIG. 3) have in common that the virtual driver 2 is also functionally connected to the vehicle actuators 6 exclusively via the interface unit 4 in the second embodiment. To transmit the control commands 124, the control unit 32 is connected to the vehicle actuators 6 via the second bus system 28.

In addition to actuating the vehicle actuators 6, the interface unit 4 is also configured to carry out a safety function 107. In the embodiments illustrated in FIGS. 1 and 3, part of the safety function 107 is that the interface unit 4 determines, as part of a permissibility check 109, whether the trajectory 103 complies with predefined constraints 111, which in this case are driving-dynamic constraints 113 of the vehicle 200. A maximum permissible lateral acceleration 115 of the vehicle 200 for the cornering shown in FIG. 2 is illustrated by the arrow 306. The driving-dynamic constraints 113 are preferably predefined taking into account various parameters, such as vehicle mass, vehicle center of gravity, payload, weather conditions, et cetera. If the vehicle 200 exceeds (that is, does not comply with) one of the predefined constraints 111 when driving along the trajectory 103, this is determined by the interface unit 4 as part of the permissibility check 109. If this is the case, the interface unit 4 does not actuate the vehicle actuators 6 using the trajectory 103.

Furthermore, the interface unit 4 is configured here to carry out fault monitoring 117. As part of fault monitoring 117, the interface unit 4 determines whether an error is present. In the embodiment shown in FIG. 3, the steering system 6.2 has an error 119, which means that steering of the vehicle 200 is only possible to a limited extent or with large curve radii. The interface unit 4 determines this error 119 by evaluating steering system status information 121 provided on the second bus system 28, which contains an error message 123. In response to this determination 125 of an error 119, the interface unit 4 determines whether the trajectory 103 is still feasible. In the illustrated embodiment, the curvature of the roadway 302 is so slight that the vehicle 200 can travel the planned route 304 even with limited steering ability. The interface unit 4 therefore determines that the trajectory 103 is still feasible.

If, on the other hand, the trajectory 103 is not feasible, for example because the curvature of the roadway 302 and the speed envisaged as part of the trajectory 103 are too great for the vehicle 200 to be able to travel the planned route 304 without exceeding the maximum permissible lateral acceleration 115, then this is determined by the interface unit 4. In this case, the interface unit 4 actuates the vehicle actuators 6 (as safety function 107) using a safety trajectory 127 instead of the trajectory 103. To obtain the safety trajectory 127, the interface unit 4 performs safety planning 129, whereby the safety planning 129 is a further sub component of the safety function 107. During safety planning 129, the interface unit 4 takes into account the predefined constraints 111 and any errors 119 of the vehicle 200, a vehicle actuator 6 or the virtual driver 2.

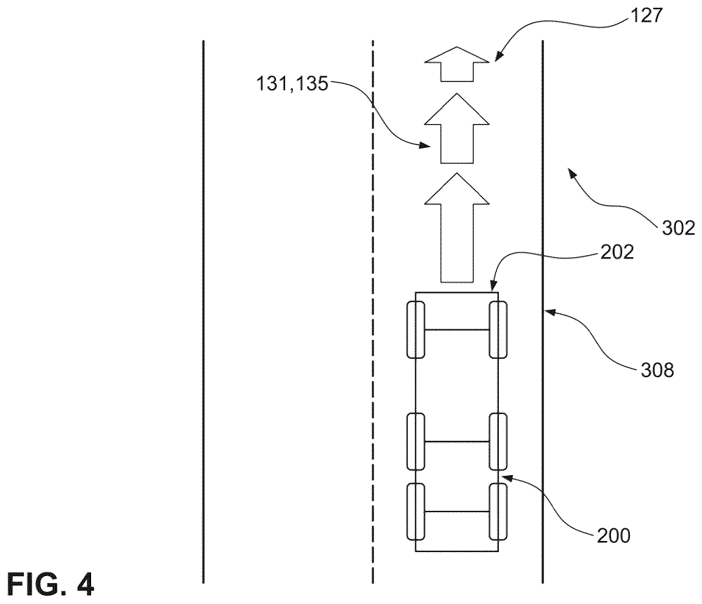

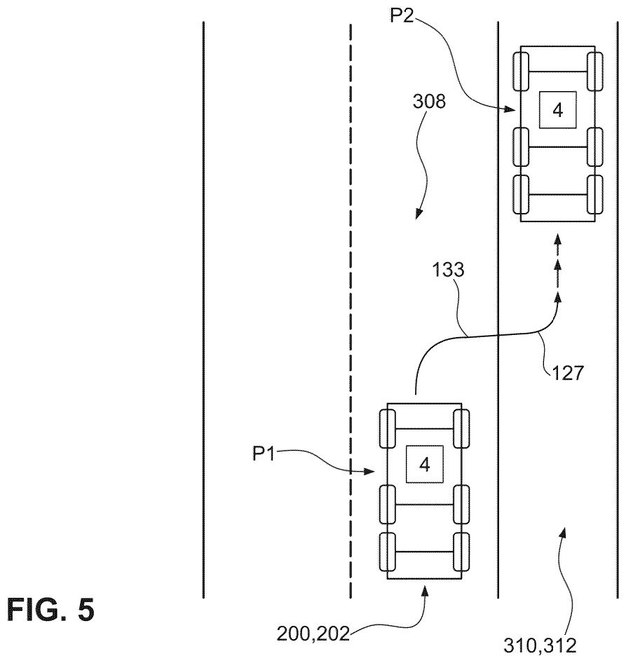

FIGS. 4 and 5 illustrate two possible safety trajectories. FIG. 4 illustrates a stop in lane maneuver 131, while FIG. 5 illustrates a stop on hard shoulder maneuver 133. In FIG. 4, the vehicle 200 is moving along a straight lane 308 of a roadway 302 that has no hard shoulder 310. If the interface unit 4 now determines that the trajectory 103 is not feasible, it controls the vehicle actuators 6 using the safety trajectory 127, which here is the stop in lane maneuver 131. Preferably, the interface unit 4 is configured to carry out the stop in lane maneuver 131 if no alternative lane 312 is available. For example, the alternative lane 312 may not be available if only one lane 308 is available, or other existing lanes are not passable due to another vehicle or an obstacle. Preferably, the interface unit 4 is configured to carry out the stop on hard shoulder maneuver 133 preferably to the stop in lane maneuver 131. Preferably, the stop in lane maneuver 131 is thus only performed if the stop on hard shoulder maneuver is not possible or not completely possible. As illustrated by the arrows extending forwardly (that is, with reference to FIG. 4, upwardly) from a vehicle front 202 of the vehicle 200 in FIG. 4, the vehicle 200 is held in the lane 308 and decelerated to a stop. According to this embodiment, the lane 308 is clear in the direction of travel of the vehicle 200 so that moderate deceleration of the vehicle 200 to a stop is possible. It should be understood that, as an alternative to the stop in lane maneuver 131, an emergency braking maneuver 135, that is, the fastest possible deceleration of the vehicle 200, can also be performed. This is particularly the case if there is insufficient braking distance for a moderate deceleration of the vehicle 200 due to an obstacle located in the lane 308.

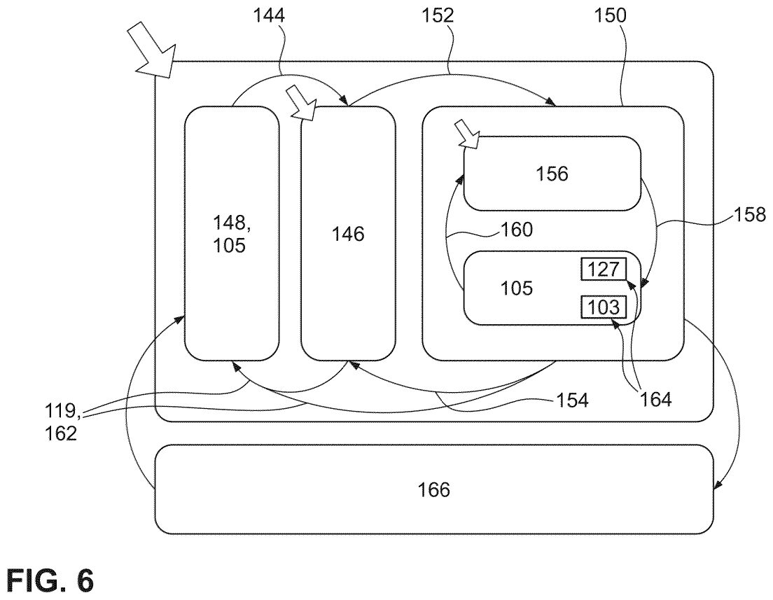

The safety trajectory 127, which is executed by the vehicle 200 shown in FIG. 6, which is configured here as a utility vehicle 204, is the stop on hard shoulder maneuver 133. In a position P1 at the beginning of the safety trajectory 127, the vehicle 200 is arranged in the lane 308. At the end of the safety trajectory 127, the vehicle 200 is stationary on the hard shoulder 310. The deceleration of the vehicle 200 is illustrated by the decreasing length of the arrows representing the safety trajectory 127 from position P1 to position P2 of the vehicle 200. The stop on hard shoulder maneuver 133 is performed because the hard shoulder 310 is present and passable. It should be understood that the stop on hard shoulder maneuver 133 may include changing lanes to an alternate lane 312 that is not a hard shoulder 310. Preferably, the stop on hard shoulder maneuver 133 and/or the stop in lane maneuver 131 may also include a momentary acceleration of the vehicle 200.

The safety trajectory 127 is always used by the interface unit 4 to control the vehicle 200 if the trajectory 103 generated by the virtual driver 2 is not feasible. In order to enable the vehicle control system 1 to react quickly in the event of an error 119 that makes it impossible to execute the trajectory 103, the interface unit 4 performs the safety planning 129 continuously and independently of the trajectory planning 101. Thus, a safety trajectory 127 is always available in the event that the trajectory 13 cannot be executed or that the virtual driver 2 does not provide a trajectory 103 due to an error 119. In the event of an error, the interface unit 4 can always transfer the vehicle 200 to a safe state, such as stopping the vehicle 200 on the hard shoulder 310.

The vehicle control system 1 according to FIG. 1 also has several sensors 34, which here are a radar sensor 34.1, a LIDAR sensor 34.2 and a stereo camera 34.3. It should be understood that the sensors 34 are only listed here by way of example, and that the vehicle control system 1 may have a large number of other sensors, such as rain sensors, wheel speed sensors, ultrasonic sensors, et cetera. The sensors 34.1, 34.2, 34.3 are used to detect the environment and provide corresponding sensor data 136, which is then taken into account in the context of trajectory planning 101 and/or safety planning 129. To provide the sensor data 136, the sensors 34 are connected to the interface unit 4 via a sensor line 36. However, it may also be provided that one or more sensors are connected to the second bus system 28 and provide the sensor data 136 on the second bus system 28. The interface unit 4 transmits the sensor data 136 via the first bus system 22 to the virtual driver 2, which then takes the sensor data 136 into account as part of the trajectory planning 101. Alternatively, the virtual driver 2 can also query the sensor data 136 at the interface unit 4.

In the first embodiment, the sensors 34 are connected to the virtual driver 2 exclusively via the interface unit 4. The interface unit 4 performs a plausibility check 137 and only transmits the sensor data 136 to the virtual driver 2 if the sensor data 136 is plausible. In the event that the sensor data 136 is implausible, for example because the radar sensor 34.1 detects an obstacle while the stereo camera 34.3 does not detect an obstacle, the interface unit 4 performs a follow up operation. The follow up operation can be, for example, a blocking (not forwarding) of sensor data 136 judged to be implausible by the interface unit 4, the execution of the stop in lane maneuver 131 and/or the execution of the stop on hard shoulder maneuver 133.

In the vehicle control system 1 according to the second embodiment (FIG. 3), the sensors 34 are directly connected to the virtual driver 2 via the sensor line 36. The virtual driver 2 provides the sensor data 136 on the first bus system 22, so that the sensor data 136 can be used by the interface unit 4 for safety planning 129. Due to the direct connection of the sensors 34 to the virtual driver 2, the sensor data 136 can be provided to the virtual driver 2 particularly quickly. The plausibility check 137 can still be carried out by the interface unit 4, as this also receives the sensor data 136. In the event that sensor data 136 is implausible, the interface unit 4 transmits a corresponding sensor error message 138 to the virtual driver 2 or makes the sensor error message 138 available on the first bus system 22. Blocking of faulty sensor data 136 by the interface unit 4, on the other hand, is not possible. It should be understood that the sensors 34 may be directly connected to the virtual driver 2 even when the virtual driver 2 is physically separated from the planning control unit 12 and the interface unit 4 is physically separated from the interface control unit 16. Similarly, even if the virtual driver 2 and the interface unit 4 are configured as virtual subsystems 30, the sensors 34 can be connected to the interface unit 4 instead of the virtual driver 2. Furthermore, one or more sensors 34 can be connected both to the virtual driver 2 and to the interface unit 4.

The vehicle control systems 1 shown in FIGS. 1 and 3 are semi-autonomous vehicle control systems 1 that can be operated both in the autonomous operating mode 105 and in a manual operating mode 140. In the manual operating mode 140, the vehicle 200 is controlled according to user specifications 140 provided by a vehicle driver to the vehicle actuators 6. By way of example, the brake system 6.1 has a brake pedal 38 via which the vehicle driver (not shown) can manually specify a desired braking action of the vehicle 200. In the manual operating mode 140, the vehicle actuators 6 are controlled only on the basis of user specifications 140 and not by the interface unit 4 using the trajectory 103. However, it may also be provided that the user specifications 140 are provided at the interface unit 4, and that the interface unit 4 is configured to actuate at least one vehicle actuator 6 using the user specification 140 in the manual operating mode 140. This is possible, for example, if the brake pedal 38 is an electric brake pedal (not shown) that provides a control signal corresponding to the user specification 140 at the interface unit 4. Preferably, the interface unit 4 can also be configured to actuate the at least one vehicle actuator 6 in a semi-autonomous operating mode using the trajectory 103 and using the user specification 140. For example, the vehicle 200 can be steered based on user specifications 140, while the interface unit 4 actuates the brake system 6.1 autonomously.

The vehicle control system 1 is switched from manual mode 140 to autonomous mode 105 by the interface unit 4. FIG. 6 illustrates this switching functionality of the vehicle control system 1. To switch the vehicle control system 1 to autonomous mode 105, the interface unit 4 first checks whether predefined activation conditions 144 are fulfilled. In this embodiment, the interface unit 4 specifically checks whether an error 119 is present. If all activation conditions 144 are fulfilled (that is, if there is no error 119 in this embodiment), the interface unit 4 switches the vehicle control system 1 to a disabled state 146. If an error 119 is detected by the interface unit 4 while the vehicle control system 1 is in the disabled state 146, then the vehicle control system 1 switches to an error state 148, which corresponds here to the manual operating mode 140.

In order to switch the vehicle control system 1 from the disabled state 146 to an enabled state 150, an activation signal 152 must be provided at the interface unit 4. For this purpose, the vehicle control system 1 has an activation switch 40, which is a toggle switch 42 in the embodiment shown in FIG. 1. The toggle switch 42 is connected to the interface unit 4 via an activation signal line 44 and provides the activation signal 152. In the embodiment shown in FIG. 3, the activation switch 40 is a pin input device 46. After a character combination has been correctly entered, the pin input device 46 provides the activation signal 152 at the interface unit 4 until the interface unit 4 switches the vehicle control system 1 to the disabled state 146 or the pin input device 46 is otherwise reset.

The vehicle control system 1 remains in the enabled state 150 until either an error 119 is detected or the activation switch 40 is deactivated. If an error is detected, the interface unit 4 switches the vehicle control system 1 back to the fault state 148. If the activation switch 40 is deactivated 154, the interface unit 4 switches the vehicle control system 1 from the enabled state 150 back to the disabled state 146. After switching to the enabled state 150, the vehicle control system 1 is initially in a passive state 156 in which the autonomous operating mode 105 is not yet active. In order to switch to autonomous mode 105, a confirmation signal 158 must first be provided. To provide this confirmation signal 158, the vehicle control system 1 also has a confirmation switch 48, which is connected to the interface unit 4 via a confirmation signal line 50. Here, the confirmation switch 48 is a button 52, which provides the confirmation signal 158 in response to a button press.

If all activation conditions 144 are met, the activation switch 40 is actuated and the interface unit 4 receives the confirmation signal 158, then the interface unit 4 switches the vehicle control system 1 from the passive state 156 to the autonomous operating mode 105. The vehicle 200 can now be controlled by the interface unit 4 using the trajectory 103.

The autonomous operating mode 105 of the vehicle control system 1 can be terminated in several ways. For example, a deactivation signal 160 can be provided to the interface unit 4 by pressing the button 52 again, which in response to receiving this deactivation signal 160 terminates the autonomous operating mode 105 and switches the vehicle control system 1 to the passive state 156. Another way to end the autonomous operating mode is to deactivate the activation switch 40 so that it no longer provides the activation signal 152. The interface unit 4 then switches the vehicle control system 1 to the disabled state 146.

The interface unit 4 is configured to react to the detection of an error 119 with various options for action. In the event that a serious error 162 is detected, which makes the autonomous operating mode 105 impossible, the interface unit 4 switches the vehicle control system 1 to the manual operating mode 140. If, on the other hand, the error 119 is only a minor error 164, the interface unit 4 retains the autonomous operating mode 105 and controls the vehicle 200 using the trajectory 103 or using the safety trajectory 127.

The vehicle control system 1 is further configured to detect an emergency braking 166 of the vehicle 200, which can also be performed by the interface unit 4 as part of the emergency braking maneuver 135. For example, the interface unit 4 may be connected to a deceleration sensor (not shown) to detect the emergency braking 166. In response to the detection of an emergency braking 166, the interface unit 4 terminates the autonomous operating mode 105 and switches to the fault state 148. If all activation conditions 144 continue to be met after the emergency braking 166, the interface unit 4 switches the vehicle control system 1 back to the disabled state 146 and, if the activation signal 152 is also provided, to the passive state. Automatic reactivation of the autonomous operating mode 105 is prevented by the fact that the confirmation signal 158 must be provided manually. The fact that the vehicle control system 1 switches to the error state 148 after detecting an emergency braking 166 ensures that the autonomous operating mode 105 can only be activated if all activation conditions 144 continue to be fulfilled. Switching to the autonomous operating mode 105 despite a vehicle system of the vehicle 200 that was damaged by the emergency braking 166 or an accident of the vehicle 200 following the emergency braking 166 is prevented.

Particularly after an emergency braking 166, but also in the general autonomous operating mode 105, the virtual driver 2 requires actuator status data 168 that characterizes the current status of the vehicle actuators 6 in order to take them into account in the trajectory planning 103. For example, the maximum braking force that can be provided by the brake system 6.1 may be reduced due to overheating of brake pads (not shown) as a result of emergency braking 166. The interface unit 4 is configured to detect and/or receive the actuator status data 168 of the vehicle actuators 6 via the second bus system 28 and provides it to the virtual driver 2 via the first bus system 22. The virtual driver 2 then takes the actuator status data 168 into account in the trajectory planning 103 and adapts, for example, a braking distance of the vehicle 200 to the maximum available braking force. In addition to the actuator status data 168, the interface unit 4 can also record vehicle status data 170 and make it available to the virtual driver 2. For example, the vehicle control system 1 can have an axle load sensor 34.4 connected to the interface unit 4, which determines an axle load and/or a payload of the vehicle 200, which the virtual driver 2 takes into account as part of the trajectory planning 101. However, vehicle status data 170 can also be, for example, temperature data and/or fuel level data, which represent a fuel level in a tank of the vehicle 200. Preferably, the interface unit 4 also takes into account the actuator status data 168 and/or the vehicle status data 170 as part of the safety planning 129. If the vehicle control system 1 is a fully autonomous vehicle control system, then the interface unit 4 does not switch from a manual operating mode 140 to the autonomous operating mode 105, but from an initial state that is present after the fully autonomous vehicle control system is started. Switching to autonomous operating mode 105 is substantially analogous to switching from manual operating mode 140 to autonomous operating mode 105.

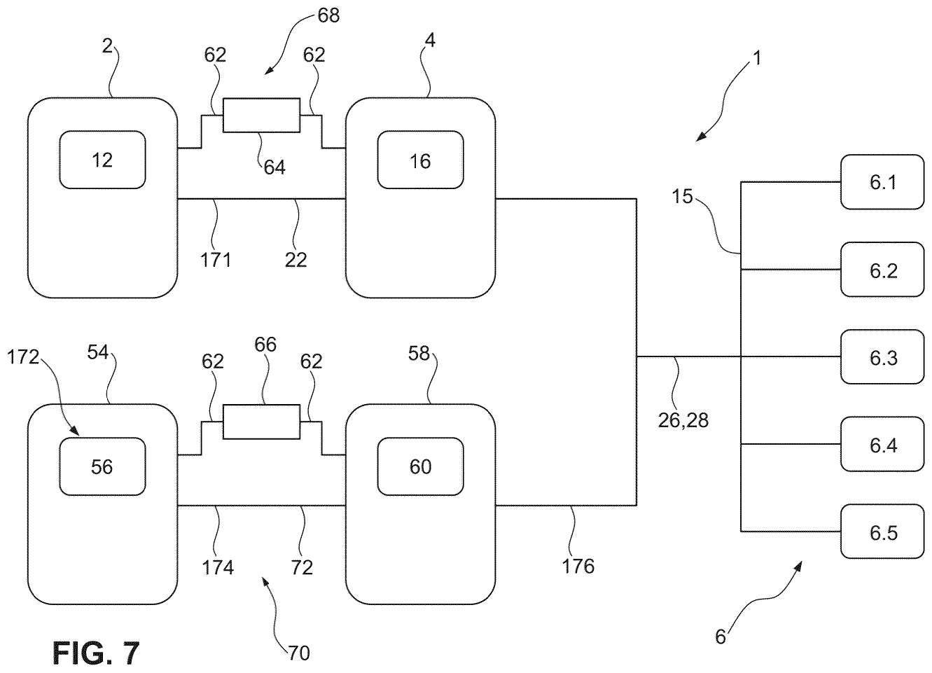

FIG. 7 shows a third embodiment of a vehicle control system 1 which, in addition to the virtual driver 2 and the interface unit 4, also has a redundancy driver 54 with a redundancy planning control unit 56 and a redundancy interface unit 58 with a redundancy interface control unit 60. The virtual driver 2 and the interface unit 4 are connected via electrical lines 62 to an operating power supply 64, which supplies the virtual driver 2 and the interface unit 4 with electrical power. The redundancy driver 54 and the redundancy interface unit 58 are supplied with electrical energy in an analogous manner from a redundancy power supply 66, which is independent of the operating power supply 64, via further electrical lines 62. The virtual driver 2, the interface unit 4 and the operating power supply 64 together form an operating control system 68. Similarly, the redundant driver 54, the redundant interface unit 58 and the redundancy power supply 66 together form a redundant control system 70. It should be understood that both the operating control system 68 and the redundant control system 70 may include other components, such as, in particular, sensors not shown in FIG. 7. In normal autonomous driving mode 105, the interface unit 4 actuates the vehicle actuators 6 using the trajectory 103.

If, on the other hand, the operating control system 68 is unable to control the vehicle due to an operating control system error 171, control of the vehicle is taken over by the redundancy control system 70. An operating control system fault 171 may be present, for example, if the operating power supply 64 fails and the virtual driver 2 and/or the interface unit 4 are not supplied with electrical power. In order to prevent a failure of the entire vehicle control system 1 in the event of a failure of the operating voltage supply 64, the redundancy control system 70 has the redundancy power supply 66 so that at least the redundancy control system 70 remains operational.

The redundancy control system 70 can have a reduced functionality compared to the operating control system 68. Thus, in this embodiment, the redundancy driving system 70 is only configured to execute maneuvers that are less complex than mission complete maneuvers. However, the redundancy control system 70 can in principle be configured identically or equivalently to the operating control system 68. The redundancy driver 54 is configured to carry out redundancy planning 172 via the redundancy planning control unit 56 in order to obtain a redundancy trajectory 174. Analogously to the operating control system 68, the redundancy interface unit 58 receives the redundancy trajectory 174 and controls the vehicle actuators 6 using this redundancy trajectory 174. For this purpose, the redundancy interface unit 58 is also connected to the vehicle actuators 6 via the second bus system 28 and can use it to provide redundancy control commands 176 to the vehicle actuators 6.

The redundancy control system 70 is configured to monitor the operating control system 68 for operating control system errors 171. The redundancy interface unit 58 of the redundancy control system 70 monitors whether the interface unit 4 is providing correct control commands 124. For example, the redundancy interface unit 58 checks here whether the control commands 124 match the redundancy control commands 176 derived by the redundancy interface unit 58 from the redundancy trajectory 174. Alternatively or additionally, however, it may also be provided that the redundancy interface unit 58 and/or the redundancy driver 54 receive the trajectory 103 and determine whether the trajectory 103 is feasible. For this purpose, a third bus system 72 of the redundancy control system 70 may be connected to the first bus system 22 (not shown). If the operating control system 68 has an operating control system error 171, the redundancy control system 70 takes over control of the vehicle 200.

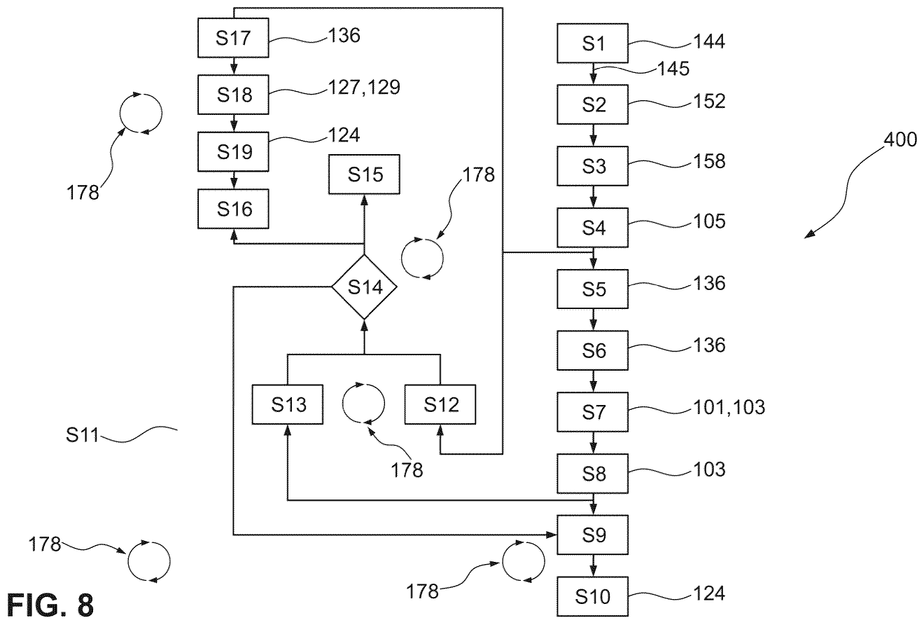

FIG. 8 illustrates a schematic flow chart for an embodiment of the method 400 for controlling a vehicle 200 with a vehicle control system 1. In a first step S1, the interface unit 4 checks whether all predefined activation conditions 144 are fulfilled. If this is the case, the interface unit issues a release 145. In a second step S2, which here follows the first step S1, the activation switch 40 of the vehicle control system 1 is actuated, thus providing the activation signal 152 at the interface unit 4. In a third step S3, which in this embodiment follows the second step S2, a confirmation signal 158 is provided at the interface unit 4 by pressing the button 52. Steps S1 and S2 can preferably also be performed in reverse order or in parallel. However, the third step S3, that is, the provision of the confirmation signal 158 at the interface unit 4, can preferably only be carried out if the activation switch 40 is actuated and all predefined activation conditions 144 are fulfilled.

In a fourth step S4, the interface unit 4 activates the autonomous operating mode 105. As can be seen from the sequence of steps S1 to S4, the activation of the autonomous operating mode (step S4) is only performed when all predefined activation conditions 144 are met, the activation switch is actuated (step S2) and the confirmation signal 158 is provided (step S3).

After activation (step S4) of the autonomous operating mode 105, the interface unit 4 records sensor data 136 from the sensors 34 (step S5) and then makes this sensor data 136 available to the virtual driver 2 (step S6). Alternatively, the virtual driver 2 can also request the sensor data 136 from the interface unit 4. The virtual driver 2 then performs trajectory planning 101 using the sensor data 136 in a seventh step S7 to obtain the trajectory 103. After performing the trajectory planning 101 (step S7), the trajectory 103 is provided to the interface unit 4 in an eighth step S8, which processes this trajectory 103 in a subsequent ninth step S9. As part of the processing (step S9), the interface unit 4 generates control commands 124 corresponding to the trajectory 103 for the vehicle actuators 6. The interface unit 4 provides these control commands 124 to the vehicle actuators 6 and thus controls the vehicle actuators 6 in a tenth step S10 to control the vehicle 200 using the trajectory 103. The repetition arrows 178 illustrate that steps S5 to S10 are carried out continuously.

Furthermore, after activation (step S4) of the autonomous operating mode 105 and preferably in parallel with one or more of the steps S5 to S10, the interface unit 4 performs a safety function 107 (step S11). The dashed line illustrates that the execution of the safety function 107 by the interface unit 4 (step S11) has several sub functions in this embodiment. Thus, in a twelfth step S12, the interface unit 4 performs fault monitoring 117 of the vehicle control system 1, the vehicle 200 and/or a vehicle subsystem to determine faults 119. After transmitting (step S8) the trajectory 103 to the interface unit 4 and preferably in parallel with fault monitoring (step S12), the interface unit 4 determines whether the trajectory 103 complies with the predefined constraints 111, in particular the driving-dynamic constraints 113 (step S13).

Following steps S12 and S13, a fourteenth step S14 determines whether or not the trajectory 103 is feasible. It should be understood that the trajectory 103 may also be feasible if driving-dynamic constraints 113 are exceeded and/or if a minor error 164 is present. For example, if only a single one of a plurality of headlights of the vehicle 200 fails (has an error 119) or a maximum lateral acceleration of the vehicle 200, which is usually predefined with safety margins, is only minimally exceeded, the trajectory 103 may still be feasible. However, the trajectory 103 may also be infeasible if, for example, it requires a strong steering maneuver of the vehicle 200 while the steering system 6.2 has an error 119. If it is determined in the fourteenth step S14 that the trajectory is still feasible, steps S9 and S10 are carried out further.

If, on the other hand, the determination (step S14) shows that the trajectory 103 is infeasible, then the vehicle control system 1 can either activate the manual operating mode 140 in a fifteenth step S15 and thus hand over control of the vehicle 200 to a driver or control at least one vehicle actuator 6 using the safety trajectory 127 (sixteenth step S16). To obtain the safety trajectory 127, the interface unit 4 acquires sensor data 136 in a seventeenth step S17, which may be identical to or different from the sensor data 136 acquired in step S6. Subsequently, the vehicle control system S1 performs safety planning 129 (eighteenth step S18) to obtain the safety trajectory 127. In this embodiment, the interface unit 4 performs the eighteenth step S18 and further processes the safety trajectory 127 in a nineteenth step S19 to again obtain control commands 124 based on the safety trajectory 127 and thereby actuate the vehicle actuators 6 in the sixteenth step S16.

Steps S11, S12, S13, S14, S17, S18 and S19 are also preferably performed continuously and are indicated by repetition arrows 178.

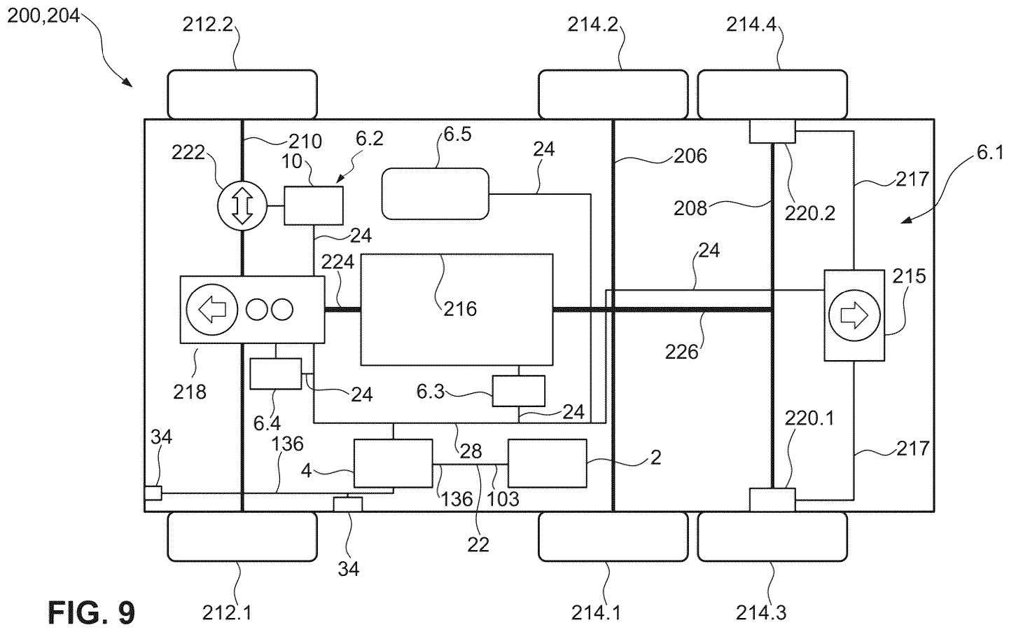

FIG. 9 further illustrates the vehicle 200, which is shown here as a utility vehicle 204 with a first rear axle 206, a second rear axle 208 and a front axle 210. Front wheels 212.1, 212.2 of the front axle 210 are configured to be steerable, while rear wheels 214.1, 214.2, 214.3, 214.4 of the first rear axle 206 and second rear axle 208 are configured as non-steerable wheels. To control the vehicle 200, the vehicle control system 1 is provided, which here includes the brake system 6.1, the steering system 6.2, the transmission control unit 6.3 connected to a transmission 216, the engine control unit 6.4 associated with an engine 218, and a main control unit 6.5. To simplify matters, the brake system 6.1 provided for decelerating the vehicle 200 here has only two brake cylinders 220.1, 220.2, which are assigned to the rear wheels 214.3, 214.4 of the second rear axle 208. The brake cylinders are connected to a brake modulator 215, which provides brake pressure for the brake cylinders 220.1, 220.2 via brake lines 217. As a rule, however, at least the front wheels 212.1, 212.2 are also provided with brake cylinders.

The steering system 6.2 is used to steer the vehicle 200. The steering control unit 10 is connected to steering actuators 222 for steering the front wheels 212.1, 212.2, which are only shown schematically here. The engine 218 is provided for accelerating the vehicle 200 or for holding the vehicle 200 at a desired speed. To transmit the drive energy provided by the engine 218 to the roadway 302, the engine 218 is connected to the second rear axle 208 of the vehicle 200 via a drive shaft 224, the transmission 216 and an output shaft 226. The transmission 216, controlled by the transmission control unit 6.3, provides a transmission ratio between the input shaft 224 and the output shaft 226. The main control unit 6.5 controls essential vehicle functions of the vehicle 200, such as a cooling system (not shown).

The brake system 6.1, the steering system 6.2, the transmission control unit 6.3, the engine control unit 6.4 and the main control unit 6.5 are connected to the interface unit 4 of the vehicle 200 via the second bus system 28. The interface unit 4 is further equipped with several sensors 34, which detect the vehicle environment and provide corresponding sensor data 136 to the interface unit 4 for the detected environment. The interface unit 4 provides the sensor data 136 via the first bus system 22 to the virtual driver 2, which takes them into account as part of the trajectory planning 101. The virtual driver 2 provides the generated trajectory 103 to the interface unit 4, which uses it to control the vehicle actuators 6. For this purpose, the interface unit 4 processes the trajectory 103 and provides control commands 24 corresponding to the trajectory 103 to the vehicle actuators 6.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1 vehicle control system
2 virtual driver
4 interface unit
6 vehicle actuators
6.1 brake system
6.2 steering system
6.3 transmission control unit
6.4 engine control unit
6.5 main control unit
8 brake control unit
10 steering control unit
12 planning control unit
14 first housing
16 interface control unit
18 second housing
20 connection
22 first bus system
26 second connection
28 second bus system
30 virtual subsystem
32 control unit
34 sensors
34.1 radar sensor
34.2 LIDAR sensor
34.3 stereo camera
34.4 axle load sensor
36 sensor line
38 brake pedal
40 activation switch
42 toggle switch
44 activation signal line
46 pin input device
48 confirmation switch
50 confirmation signal line
52 button
54 redundancy driver
56 redundancy planning control unit
58 redundancy interface unit
60 redundancy interface control unit
62 electrical lines
64 operating voltage supply
66 redundancy power supply
68 operating control system
70 redundancy control system
72 third bus system
101 trajectory planning
103 trajectory
105 autonomous operating mode
107 safety function
109 admissibility check
111 predefined constraints
113 driving-dynamic constraints
115 permissible lateral acceleration
117 error monitoring
119 error
121 steering system status information
123 error message
124 control commands
125 determination of an error
127 safety trajectory
129 safety planning
131 stop in lane maneuver
133 stop on hard shoulder maneuver
135 emergency braking maneuver
136 sensor data
137 plausibility check
138 sensor error message
140 manual operating mode
142 user specifications
144 activation conditions
145 release
146 disabled state
148 error state
150 enabled state
152 activation signal
154 deactivation
156 passive state
158 confirmation signal
160 deactivation signal
162 serious error
164 minor error
166 emergency braking
168 actuator status data
170 vehicle status data
171 operating control system error
172 redundancy planning
174 redundancy trajectory
176 redundancy control commands
178 repetition arrows
200 vehicle
202 vehicle front
204 utility vehicle
206 first rear axle
208 second rear axle
210 front axle
212.1, 212.2 front wheels
214.1, 214.2 rear wheels
214.3, 214.4 rear wheels
215 brake modulator
216 transmission
217 brake lines
218 engine
220.1, 220.2 brake cylinder
222 steering actuators
224 drive shaft
226 output shaft
302 roadway
304 planned route
306 arrow
308 lane
310 hard shoulder
312 alternative lane
400 method
S1 first step: check whether activation conditions are met
S2 second step: actuate an activation switch
S3 third step: provide a confirmation signal
S4 fourth step: activate an autonomous operating mode
S5 fifth step: detect sensor data
S6 sixth step: provide sensor data
S7 seventh step: carry out trajectory planning
S8 eighth step: provide the trajectory
S9 ninth step: process the trajectory
S10 tenth step: actuate vehicle actuators to control the vehicle using the trajectory
S11 eleventh step: perform a safety function
S12 twelfth step: error monitoring
S13 thirteenth step: determine whether the trajectory complies with predefined constraints
S14 fourteenth step: determine whether the trajectory is feasible
S15 fifteenth step: activate a manual operating mode
S16 sixteenth step: actuate vehicle actuators using a safety trajectory seventeenth step: collect sensor data
S17
S18 eighteenth step: carry out safety planning nineteenth step: process the safety trajectory S19

1. A vehicle control system for controlling a vehicle in an autonomous operating mode, the vehicle control system comprising:
a virtual driver configured to carry out trajectory planning to generate a trajectory;
wherein the vehicle control system is configured to control the vehicle using the trajectory;
at least one vehicle actuator; and,
an interface unit configured to obtain the trajectory from said virtual driver and to actuate said at least one vehicle actuator to control the vehicle using the trajectory, wherein said interface unit functionally connects said virtual driver and said at least one vehicle actuator.

2. The vehicle control system of claim 1, wherein said virtual driver has a planning control unit for carrying out the trajectory planning; and, said interface unit has an electronic interface control unit, which is formed independently of said planning control unit and is configured to process the trajectory.

3. The vehicle control system of claim 2 further comprising:
a first bus system;
a second bus system;
said virtual driver being connected to said first bus system;
said at least one vehicle actuator being connected to said second bus system; and,
said interface unit being connected to said first bus system and said second bus system.

4. The vehicle control system of claim 1, wherein said interface unit is configured to carry a safety function of the vehicle control system; and, said safety function is an admissibility check provided to determine whether the trajectory complies with one or more predefined constraints.

5. The vehicle control system of claim 4, wherein said one or more predefined constraints is a predefined driving dynamic constraint for the vehicle.

6. The vehicle control system of claim 1, wherein said interface unit is configured to carry a safety function of the vehicle control system; said safety function is an error monitoring provided to determine whether an error of at least one of the vehicle control system, the vehicle, and a vehicle subsystem is present; and, said interface unit is configured to determine whether the trajectory is feasible in response to a determination of the error of the at least one of the vehicle control system, the vehicle, and the vehicle subsystem.

7. The vehicle control system of claim 1, wherein said interface unit is configured to drive said at least one vehicle actuator of the vehicle control system for controlling the vehicle using a safety trajectory calculated with a safety function, which includes performing safety planning, if the trajectory violates one or more predefined constraints.

8. The vehicle control system of claim 7, wherein the one or more predefined constraints includes a driving-dynamic constraint predefined for the vehicle.

9. The vehicle control system of claim 7, wherein the safety trajectory describes or includes at least one of: an emergency braking maneuver, a stop in lane maneuver, a stop on hard shoulder maneuver, a limp home maneuver, and a mission complete maneuver.

10. The vehicle control system of claim 7, wherein said interface unit is configured to take into account a determined fault of at least one of the vehicle control system, the vehicle, and a vehicle subsystem in the safety planning.

11. The vehicle control system of claim 7, wherein said interface unit is configured to carry out the safety planning regardless of whether or not the trajectory is feasible.

12. The vehicle control system of claim 1, wherein said interface unit is configured to switch between the autonomous operating mode and a manual operating mode of the vehicle control system; and, said interface unit actuates said at least one vehicle actuator only when the autonomous operating mode is activated.

13. The vehicle control system of claim 12 further comprising:
an activation switch; and,
said interface unit being configured to switch to the autonomous operating mode only when said activation switch is actuated.

14. The vehicle control system of claim 13, wherein said interface unit is configured to switch to the autonomous operating mode only when said activation switch is actuated and a confirmation signal is provided at said interface unit.

15. The vehicle control system of claim 14, wherein the confirmation signal is only providable at said interface unit when said interface unit issues a release; and, said interface unit is configured to determine whether predefined activation conditions are met and to issue the release only when the predefined activation conditions are met.

16. The vehicle control system of claim 1, wherein said interface unit is configured to detect and/or to receive at least one of actuator status data from said at least one vehicle actuator and vehicle status data and to provide it to said virtual driver.

17. The vehicle control system of claim 1, wherein said interface unit is a virtual subsystem of at least one of a brake control unit of a brake system, a steering control unit of a steering system, a transmission control unit, an engine control unit, and a main control unit of the vehicle.

18. The vehicle control system of claim 1 further comprising:
at least one of a redundancy driver and a redundancy interface unit;
at least one of said virtual driver and said interface unit being supplied by an operating voltage supply;
said at least one of said redundancy driver and said redundancy interface unit being supplied by a redundancy voltage supply independent of the operating voltage supply; and,
wherein at least one of:
said redundancy driver has a reduced functionality compared to said virtual driver; and,
said redundancy interface unit has a reduced functionality compared to said interface unit.

19. The vehicle control system of claim 1, wherein the vehicle is a utility vehicle.

20. A method for controlling a vehicle with a vehicle control system, the method comprising:
performing trajectory planning to obtain a trajectory via a virtual driver when an autonomous operating mode is activated;
providing the trajectory at an interface unit;
processing of the trajectory by the interface unit, which is independent of the virtual driver; and,
actuating at least one vehicle actuator of the vehicle control system to control the vehicle by the interface unit using the trajectory.

21. The method of claim 20, wherein the vehicle control system includes:
a virtual driver configured to carry out trajectory planning to generate a trajectory;
wherein the vehicle control system is configured to control the vehicle using the trajectory;
at least one vehicle actuator; and,
an interface unit configured to obtain the trajectory from said virtual driver and to actuate said at least one vehicle actuator to control the vehicle using the trajectory, wherein said interface unit functionally connects said virtual driver and said at least one vehicle actuator.

22. The method of claim 20, wherein at least one of data and signals are transmitted exclusively via the interface unit between the virtual driver and the at least one vehicle actuator.

23. The method of claim 20 further comprising carrying out a safety function by the interface unit.

24. The method of claim 23, wherein said carrying out the safety function includes:
fault monitoring of at least one of the vehicle control system, the vehicle and a vehicle subsystem for determining faults.

25. The method of claim 24, wherein said carrying out the safety function further includes:
determining whether the trajectory is feasible if an error of at least one of the vehicle control system, the vehicle, and a vehicle subsystem is determined.

26. The method of claim 23, wherein said carrying out the safety function includes:
performing a safety planning to obtain a safety trajectory; and,
actuating at least one vehicle actuator of the vehicle control system using the safety trajectory.

27. The method of claim 23, wherein said carrying out the safety function includes:
performing a safety planning to obtain a safety trajectory; and,
actuating at least one vehicle actuator of the vehicle control system using the safety trajectory in response to a determination that the trajectory cannot be performed or cannot be performed correctly.

28. The method of claim 23 further comprising:
detecting at least one of sensor data and sensor signals via the interface unit; and,
providing the at least one of the sensor data and the sensor signals to the virtual driver by the interface unit and/or querying the at least one of the sensor data and the sensor signals from the interface unit by the virtual driver.

29. The method of claim 23 further comprising:
activating the autonomous operating mode by the interface unit.

30. The method of claim 29 further comprising:
actuating an activation switch; and,
wherein the activation of the autonomous operating mode is only carried out when the activation switch is actuated.

31. The method of claim 30 further comprising:
providing a confirmation signal; and,
wherein the activation of the autonomous operating mode is only performed when the activation switch is actuated and the confirmation signal is provided.

32. The method of claim 30 further comprising:
checking whether predefined activation conditions are fulfilled by the interface unit, wherein said providing the confirmation signal is only possible if all predefined activation conditions are fulfilled.

33. The method of claim 20 further comprising:
determining whether the trajectory complies with one or more predefined constraints; and,
wherein the actuation of at least one vehicle actuator of the vehicle control system for controlling the vehicle is performed by the interface unit using the trajectory only if the trajectory complies with all predefined constraints.

34. The method of claim 33, wherein the one or more predefined constraints include driving-dynamic constraints predefined for the vehicle.

35. A vehicle comprising the vehicle control system of claim 1.
